(19) United States
(12) Patent Application Publication
(10) Pub. No.: US 2011/0238498 A1
(43) Pub. Date: Sep. 29, 2011

(54) SERVICE STAGE FOR SUBSCRIPTION MANAGEMENT

(75) Inventors: Amer A. Hassan, Kirkland, WA (US); PehKeong Teh, Redmond, WA (US); Andrew T. Baron, Redmond, WA (US); Billy R. Anders, JR., Bothell, WA (US); Shai Guday, Remond, WA (US)

(73) Assignee: Microsoft Corporation, Redmond, WA (US)

(21) Appl. No.: 12/748,829

(22) Filed: Mar. 29, 2010

(51) Int. Cl. G06Q 30/00; G06F 3/048; G06F 3/01; G06F 9/00; G06Q 99/00; G06Q 20/00

(52) U.S. Cl. 705/14.53; 715/835; 715/708; 713/1; 705/40; 705/27.1

(57) ABSTRACT

A utility for managing subscriptions for multiple services in a consistent fashion. The utility may collect information from multiple service providers and present the information to a user in a consistent format. A user interface component may control the user interface during performing actions associated with managing subscriptions, regardless of the specific service for which management operations are performed. The utility may include a feedback component, providing feedback relating to a user such that service providers can elect to supply offers for additional services or service features that align with a user's interests.

### BACKGROUND

In today's era of increased specialization, people frequently rely on numerous service providers to provide them with services needed in the personal and business lives. People may subscribe to communication services, entertainment services, energy services, as just some examples of the many types of services that are available.

In many instances, people subscribe to these services by entering into an agreement with a service provider. A subscription agreement may specify terms of use and payment. From time to time, a subscriber may wish to obtain information about a service or its terms of a subscription agreement. As one example, some subscription agreements impose usage limits on the service, with additional fees if the usage limits are exceeded, and a subscriber may wish to compare their usage to agreed limits. A user may also wish to manage a service, such as by subscribing to new services or new features of a service to which the user has previously subscribed.

Frequently, service providers provide websites through which subscribers can obtain information about their subscriptions. On line access to subscription information may also allow users to manage their subscriptions, such as by selecting different service plans or service options. Further, on line access to subscription information can allow those interested in receiving a service to subscribe to it.

### SUMMARY

The inventors have recognized and appreciated the desirability of a utility that aids computer users manage multiple subscriptions. The subscriptions may relate to different categories of services, which may be characterized by different parameters. Nonetheless, the utility may provide a consistent interface to disparate services and may provide a consistent interface to the user, even if the user is in different locations or managing the services from different computing devices.

A framework established by the utility may enable service providers to present useful and relevant information to customers using their services or to prospective customers. This information may be based on feedback from a user or, with user consent, about the user.

Despite the need for a user to interact with different service providers, a user may be able to perform common actions using the utility. These actions may include subscribing to the service, obtaining usage information, making payments or receiving offers for additional features or services from one or more service providers.

In some aspects, the framework may include a service management engine that collects subscription related information from service providers and associates it with one or more subscribers. The service management engine can supply this data, collected from multiple service providers, to a service stage for a user or users. The service stage may control a user experience so that the user has a consistent experience regardless of the specific service for which a subscription is managed through the framework.

A feedback engine may, with user consent, provide feedback on the user to one or more service providers. Service providers may use the feedback to identify additional service features or additional services that are likely to be of interest to the user. The service providers may provide advertisements or offers for these additional services or service features to the framework. The framework, in turn, may present such offers or advertisements to a user at a relevant time.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of an environment in which embodiments of the invention may operate;

FIG. 2A is a conceptual block diagram of a user computer configured with a subscription management system according to some embodiments;

FIG. 2B is a conceptual illustration of a local database stored in the user computer of FIG. 2A;

FIG. 3 is a functional block diagram of a service management engine that may be included in a subscription management system according to some embodiments;

FIG. 4 is a functional block diagram of a service stage that may be included in a subscription management system according to some embodiments;

FIG. 5 is a sketch of a graphical user interface that may be provided by the service stage of FIG. 4 in accordance with some embodiments;

FIG. 6A is a sketch of a graphical user interface through which a user may manage a first service selected through the graphical user interface of FIG. 5;

FIG. 6B is a sketch of a graphical user interface through which a user may manage a second service selected through the graphical user interface of FIG. 5;

FIG. 7 is a sketch of a subscription management system accessed through a portable electronic device according to some embodiments;

FIGS. 8A, 8B, 8C and 8D are conceptual illustrations of messages that may be sent from service providers to a subscription management system according to some embodiments; and

FIGS. 9A, 9B, 9C and 9D are conceptual illustrations of messages that may be sent from a subscription management system to service providers according to some embodiments.

### DETAILED DESCRIPTION

The inventors have recognized and appreciated that the number of services to which a typical computer user is likely to subscribe is increasing. Though many service providers host web sites that allow their subscribers to obtain information about services or to manage services on-line, the number of services to which a user may subscribe poses practical difficulties of remembering how to access a number of websites. Moreover, such websites are generally based on a pull model, such that they provide information only in response to user initiated requests. Service providers are limited in the ways they can provide information about service changes, new features or new services. Accordingly, even if the user can remember how to access service provider websites, if the user does not frequently access those websites seeking out information, the user may not timely receive relevant information about service offerings.

The inventors have also recognized and appreciated that an experience for a user of a computing device could be improved by providing a mechanism to manage subscriptions for multiple services in a consistent way. Rather than being forced to access websites for individual service providers, a user may provide and receive information through a common interface using consistent tools. The utility, relying on a framework for interaction with service providers, may exchange this information with service providers.

Accordingly, in some embodiments, a utility is provided that exchanges information between service providers and their subscribers. These interactions allow users to access information about subscriptions and to control the subscriptions. The same interface elements may be available, regardless of the nature of the service, allowing a user to manage subscriptions for disparate services in a consistent way. For example, services relating to utilities, banking, and entertainment may all be managed in a consistent way.

The utility may be implemented using multiple components, some of or all of which may be resident on a user computer that is networked to websites or other computers operated by service providers. Though, in some embodiments, some of the components of the platform may be resident on computer systems operated by an intermediary that interfaces to both users and service providers.

The utility may include multiple components, one of which may be a service management engine. The service management engine may interface to multiple service providers. Interfacing may involve multiple functions, including collecting data from the service providers. Such data may be collected from multiple service providers, regardless of the nature of the services they provide. Interfacing may also entail communicating information from subscribers or related to subscribers back to the service providers. In some instances, the service management engine may create tunnels or otherwise facilitate communication from a user to computer systems operated by service providers. Such communication may be based on explicit user input, such as a request for information about a service or a command to change some parameter of a subscription. Alternatively, communication from a user computer to a service provider may report actions of the user, which may signify a need or desire of the user for an additional service or other information that, though unsolicited, may improve the user experience.

Though the utility may support a variety of forms of communications between users and multiple service providers of different types, a burden on a user of these communications may be limited by providing consistency of user experience across interactions involving different service providers. To aid in providing consistency of user experience, a further component of the utility may be a service stage. The service management engine may interface with the service stage such that the service stage may present information through a user interface. The service stage may also control a user's experience while the user is managing services, allowing a user to receive information about subscription parameters, such as service usage, service limits or offers for additional services or features, from multiple service providers in a consistent fashion.

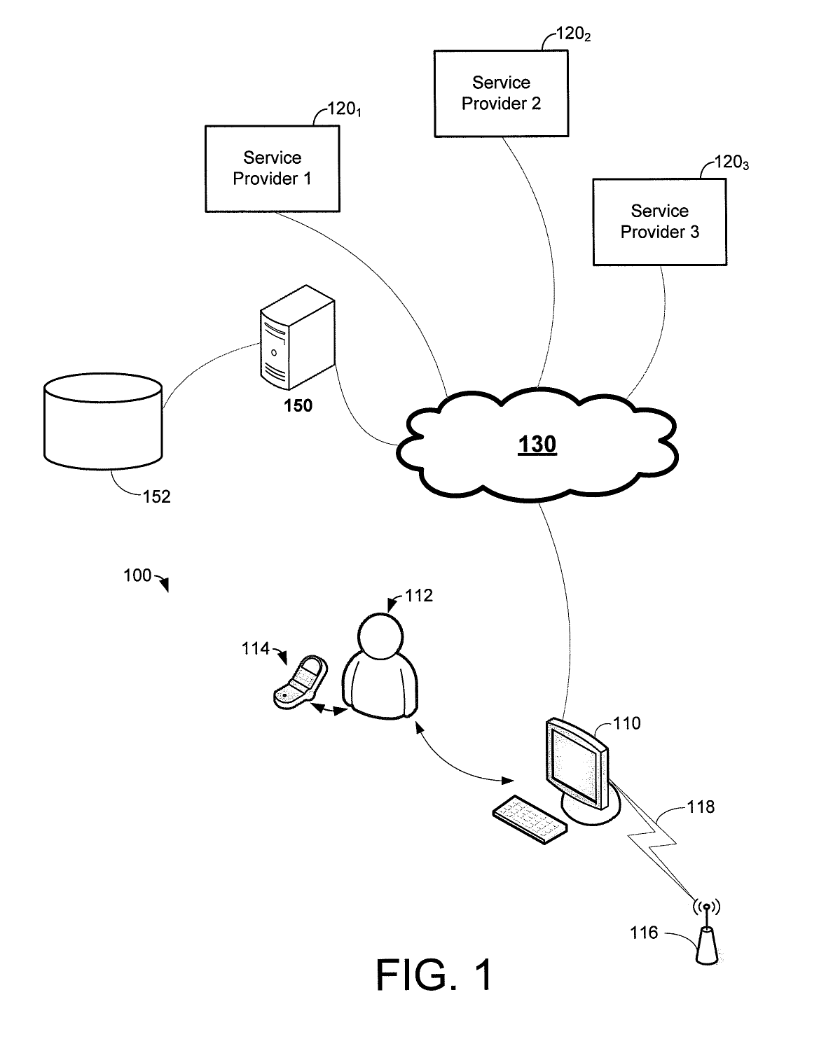

In accordance with some embodiments, the subscription management utility may operate in a user computer. Turning to FIG. 1, an exemplary environment in which embodiments of a service management utility may operate is illustrated. Environment 100 may include a user computer 110. User computer 110 may be any suitable computing device. In this example, user computer 110 is illustrated as a personal desktop computer such as may be present in a home of a person who subscribes to multiple services. However, the format of user computer 110 is not a limitation on the device.

Regardless of the form of user computer 110, a subscription management utility may execute on user computer 110. A user 112 may interact with the subscription management utility through input/output devices of user computer 110 to manage multiple subscriptions for services.

The managed services may be of multiple different types. For example, user 112 is shown to have cellular telephone 114. Cellular telephone 114 may require a subscription to a wireless communication service to operate. Such a service may be provided by a wireless carrier or other service provider.

Wireless communication services are one example of the type of services to which a user may subscribe. As another example, environment 100 illustrates that user computer 110 is connected to a public network 130. Access to public network 130 may be possible because user 112 subscribes to a digital data service offered by an Internet service provider. Additionally, in environment 100 user computer 110 is coupled through a wireless connection 118 to an access point 116. Access point 116 may provide access to network services offered by another service provider.

FIG. 1 provides multiple examples of services to which a user 112 may subscribe. The services illustrated in FIG. 1 allow computerized devices, such as cell phone 114 or user computer 110, to communicate. However, a subscription management utility may operate with other types of services, even those unrelated to operation of a computer. For example, a user may obtain electricity from an electrical service provider or may obtain other utility services from other utility companies acting as service providers.

Further, user 112 may obtain services from any number or type of businesses acting as service providers, even those not traditionally called service providers. In some embodiments, user 112 may use a subscription management utility within user computer 110 to manage banking services offered by a bank or entertainment services, such as the download of movies or music, offered by other businesses. As a further example of services, user 112 may purchase prepaid services from any number or type of businesses. As a specific example, user 112 may purchase a number of oil changes or service visits for the user's automobile from a garage acting as a service provider.

The foregoing examples illustrate that user 112 may subscribe to any number of services that may be of different types. Each of these services may entail a subscription agreement of some form, though the subscription agreement for each may have different parameters characterizing an associated service. For example, a subscription agreement for cellular telephone service may have parameters such as a monthly charge, an allowance of minutes per month and a charge for minutes of usage that exceed the allocation. A subscription agreement with a garage that provides oil change services may have vastly different parameters. Such a subscription agreement, for example, may have parameters related to the number of service visits to which the user is entitled and a date at which that entitlement expires. As an example of a further difference, a subscription agreement may not entail direct payment for access to a service. Rather, the subscription agreement may entail only agreement to terms on which the service provider provides services.

Despite these differences, a subscription management utility as described herein may interface with multiple service providers to exchange information related to subscriptions entered into by user 112. In the embodiment illustrated in FIG. 1, user computer 110 is coupled to multiple service providers over a network 130. Network 130 may be the Internet or any other suitable network. In this example, three service providers, service provider 120₁, 120₂ and 120₃ are illustrated. It should be recognized that only three service providers are illustrated for simplicity. Also, it should be recognized that FIG. 1 illustrates a system from the perspective of a single user, user 112. Each of the service providers, such as service providers 120₁, 120₂ and 120₃, may interface with multiple users, which also are not shown for simplicity. Accordingly, environment 100 may include many more than three service providers and each of the service providers may interface with service management utilities of multiple computer users.

Regardless of the number of service providers and the nature of the services that each provides, each of the service providers with which a subscription management utility interacts may have a website or other mechanism to interact with user computer 110 over network 130. User computer 110 may interact directly with each of the service providers 120₁, 120₂ and 120₃ or through an intermediary.

In the example environment 100 of FIG. 1, a server 150 also coupled to network 130 may act as an intermediary. Server 150 may be programmed to interact with service providers, such as service providers 120₁, 120₂ and 120₃. Intermediary 150 may relay communications from user computer 110 to one or more of the service providers 120₁, 120₂ or 120₃. Likewise, server 150 may relay communications from any of the service providers 120₁, 120₂ or 120₃ to user computer 110.

In the embodiment illustrated, server 150 is shown coupled to a database 152. Database 152 may contain any information that may be passed between service providers and user computer 110. Such information may relate to such things as services, users or subscriptions. Though, as noted above, a service management utility on a user computer may communicate directly with service providers such that no intermediary is used for operation of the utility. In other embodiments, the intermediary is used to initially connect a service management utility to service providers. In this case, database 152 may store a directory of service providers that is accessed by service management utility on user computer 110 to initially contact service providers.

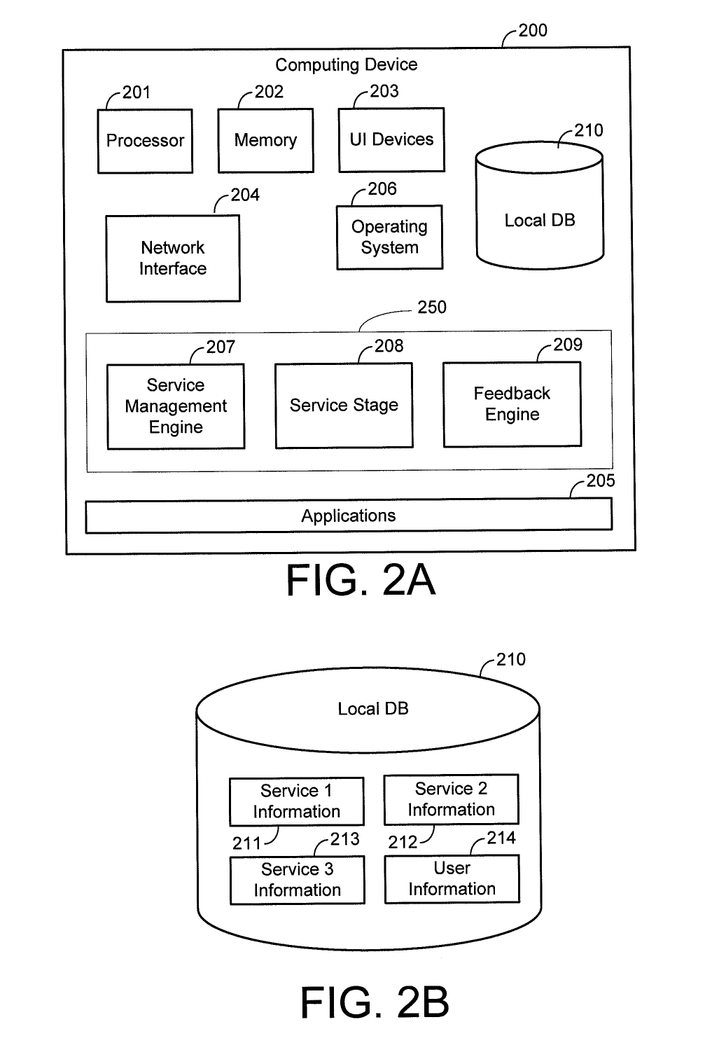

Though, as noted above, some or all of the service management utility may reside on a user computer. FIG. 2A shows a block diagram of a user device 200 service management utility according to some embodiments. User device 200 may be any suitable type of computing device. For example and not limitation, user device may be user computer 110 illustrated in exemplary environment 100 (FIG. 1). User device 200 is illustrative and a specific embodiment of a user device may have components other than the components show in FIG. 2A. In some embodiments, user device 200 comprises a processor 201, memory 202, user interface (UI) devices 203 and network interfaces 204.

Processor 201 may be a processor, or combination of processors or processor cores, as known in the art or any suitable processing device. For example and not limitation, processor 201 may be a central processing unit (CPU), digital signal processor (DSP), controller, addressable controller, general or special purpose microprocessor, microcontroller, addressable microprocessor, programmable processor, programmable controller, dedicated processor, dedicated controller, or any other suitable processing device.

Memory 202 may store data and/or software modules containing computer-executable instructions that when executed by processor 201 perform a desired function. Memory 202 may be a computer-readable storage medium as is known in the art or any suitable type of computer-readable storage medium. For example and not limitation, memory 202 may be RAM, a nanotechnology-based memory, one or more floppy discs, compact discs, optical discs, volatile and non-volatile memory devices, magnetic tapes, flash memories, hard disk drive, circuit configurations in Field Programmable Gate Arrays, other semiconductor devices, or other tangible computer storage medium or combination thereof.

UI devices 203 may include any type of UI device for providing and/or receiving information including user interface devices as known in the art. I/O devices 103 may include, for example and not limitation, a keypad such as a keyboard, pointing device such as a mouse or trackball, microphone, joystick, touch screen display, display, speaker, removable storage drives, or a combination thereof.

User device 200 may include any suitable number of network interfaces 204. Each network interface may be an interface suitable for wired and/or wireless communication and may be implemented through any suitable combination of hardware and software configured to communicate over a network. For example, a network interface may be implemented as a network interface driver and a network interface card (NIC). The driver may be configured to receive instructions from other components of user device 200 to perform operations with the NIC.

A wired network interface may be any suitable type of interface for connecting to a network over a wire (e.g., Ethernet, fiber-optic, coaxial).

A wireless network interface may contain hardware components, such as a transmitter and receiver to receive and transmit information wirelessly to and from user device 200. Each wireless network interface may be configured to support any suitable wireless communications protocol. For example, a wireless interface may be configured to support any standard or proprietary communications protocol, such as those for wireless personal area network (WPAN), wireless local area network (WLAN), wireless local area network (WLAN), wireless metropolitan area networks (wireless MAN), wireless wide area network (WWAN), or other types of networks. Network interfaces 204 may, for example and not limitation, be configured for use with any of IEEE 802.11, Wi-Fi, ultra-wide band (UWB) technologies, Bluetooth, Wireless USB, WiMedia, WiMax, Wireless 1394, Code Division Multiple Access (CDMA), Time Division Multiple Access (TDMA), Global System for Mobilization (GSM), Cellular Digital Packet Data (GPRS), or General Packet Radio Service (GPRS).

User device 200 may also include modules configured to perform specific functions. In the illustrated embodiment, user device 200 includes an operating system 206 (OS) and applications 205. Though, user device 200 may have any suitable modules. Modules may be implemented in hardware, software, or any suitable combination thereof. In some embodiments, a module may comprise computer-executable instructions. The instructions may be stored in memory 202 and executed by processor 201.

OS 206 may manage the activities and sharing of resources of user device 200. OS 206 may provide various functions and manage user device 200 through various components. These components may include, for example and not limitation, dynamically linked libraries (e.g., a dynamic-link library), application programming interfaces (APIs), component object models (COMs), globally unique identifiers, registry keys, or any uniquely identifiable part of OS 206. The operating system may also aid in operation of a user interface on behalf of other components. As described below, some components may generate user interfaces that include controls that may be selected by a user. The operating system may control the process of receiving that user input and invoking a component that is linked to the control to provide a desired function upon user selection.

Applications 205 may include any suitable computer applications, including applications as now known or hereafter developed. In the embodiment illustrated, applications 205 may consume network resources. For example, applications 205 may send and receive e-mails, download files or access web pages. Though, user device 200 may include any suitable applications.

OS 206 may be implemented using techniques as are now known in the art for implementing operating systems. Though, any suitable techniques, whether now known or hereafter developed, may be used to implement OS 206. In some embodiments, operating system 206 may be a conventional operating system. Though, in other embodiments, the operating system of user device 200 may be modified by inclusion of a service management utility.

In the example of FIG. 2A, service management utility 250 is shown separate from OS 206. Though, in some embodiments, service management utility 250 may be implemented as an operating system component. Regardless of whether service management utility 250 is implemented as part of OS 206, it may be implemented using known techniques for implementation of computerized components. In the embodiment illustrated, service management utility 250 is implemented as computer-executable instructions encoded on a non-transient computer storage medium, such as memory 202, that are executed on a processor, such as processor 201. Known programming techniques may be used to develop such computer-executable instructions adapted to perform the functions described herein.

In the embodiment illustrated in FIG. 2A, subscription management utility 250 contains multiple components. These components interact to obtain subscription related information from multiple service providers, integrate the information into a common user experience that allows a user to receive information and input commands for managing subscriptions with the multiple service providers. Additionally, the components of subscription management utility 250 convey commands related to subscription management to the service providers.

Further, components of subscription management utility 250 may provide to the service providers information relating to user actions. The subscription management utility 250 may obtain the information about user actions by monitoring user interaction with user device 200. Though, such information may be obtained in other ways, such as by user input of a user profile. In the course of managing subscriptions, subscription management utility 250 may obtain and store information related to services for which subscriptions are in place. Additionally, subscription management utility 250 may generate or access user information.

The information obtained, generated or accessed by subscription management utility may be stored on user device 200. FIG. 2A illustrates a local database 210 on user device 200. Local database 210 may be implemented by data stored, with any suitable organization, in memory 202 or other computer storage media associated with user device 200. Though, it should be recognized that FIG. 2A illustrates only one possible embodiment of a user device 200 configured with a subscription management utility. Some or all of the data generated or accessed during operation of subscription management utility 250 may be stored externally to user device 200. As one example, FIG. 1 illustrates an environment 100 in which a server 150 is coupled to a network database 152, which may store information accessed by subscription management utility 250. Accordingly, though FIG. 2A illustrates an embodiment in which data is stored locally, it should be recognized that FIG. 2A is illustrative and not a limiting example.

FIG. 2B illustrates an example of local database 210. As shown, multiple types of information may be stored in local database 210. Though local database 210 may be implemented as a single file or unit of information stored within user device 200, it should be recognized that local database 210 may alternatively be implemented as multiple files or multiple units of information stored in one or more locations associated with user device 200. Accordingly, the format with which information within local database 210 is stored is not critical to the invention.

In the example of FIG. 2B, local database stores information concerning each of the services to which a user of user device 200 has subscriptions. In the example, of FIG. 1, user 112 has subscriptions to services provided by three service providers. Accordingly, local data base 210 is shown to contain information about three services. Service information 211 may relate to a service provided by service provider 120₁ (FIG.1). Service information 212 may relate to a service provided by service provider 120₂ (FIG. 1). Similarly, service information 213 may relate to a service provided by service provider 120₃ (FIG. 1). Such information may identify the type of service, the service provider from which the service is obtained and/or contact information for the service provider. The contact information, for example, may include such items as a network address through which the service provider may be contacted and credentials, such as the user name and password, that may be used to access subscription information related to user 112 maintained by the respective service provider. The stored information about a service may further include one or more parameters of a subscription for the associated service. Additionally, service information 211, 212 and 213 may include information about a user's usage of that service.

User information 214 may contain any information about user 112 useful in subscription management. User information 114 may contain identifying information about user 112 that is independent of the provision of any service, such as the user's name and address or other contact information. Additionally, user information 214 may contain a user profile, defining preferences of user 112. Profile information may be expressly entered into local database 210 by a user and may relate specifically to preferences for receiving services. Though, the profile information may be obtained in other ways, such as from context or monitoring user actions.

Such information may be used in providing feedback to service providers to enable the service providers to tailor service offerings to a specific user. In this context, it should be recognized that user information 214 need not be limited to only information related to preferences for receiving services. User information 214 may contain general information about categories of interest to user 112. Such category information may be obtained using techniques as are known in the art or in any other suitable way. As one example, user profile information may indicate one or more interest categories into which user 112 has been assigned based on websites accessed by user 112.

In the embodiment illustrated, local database 210 stores information relating to a single user. In some embodiments, multiple users may access user device 200. Accordingly, subscription management utility 250 may store multiple local databases, each corresponding to a user or group of users. Subscriptions management utility 250 may access an appropriate copy of local database 210 based on the specific user currently accessing the utility to manage subscriptions.

To facilitate the exchange of information between a user and one or more service providers, service management utility 250 may include multiple components. In the illustrated embodiment, three components are illustrated. In the example, service management utility 250 includes service management engine 207, service stage 208 and feedback engine 209. Feedback engine may operate with user consent, to provide information about a user, including an expressed or implied interest in a service or category of services. This information may be generated by monitoring a user's use of service or other actions, such as searching for specific types of information using applications that are unrelated to service management. Regardless of how the information is collected, feedback engine 209 may provide the information to one or more service providers. The service providers may use this information to select advertisements or promotions that may be of interest to the user, which may be offered to the user in a relevant and consistent way.

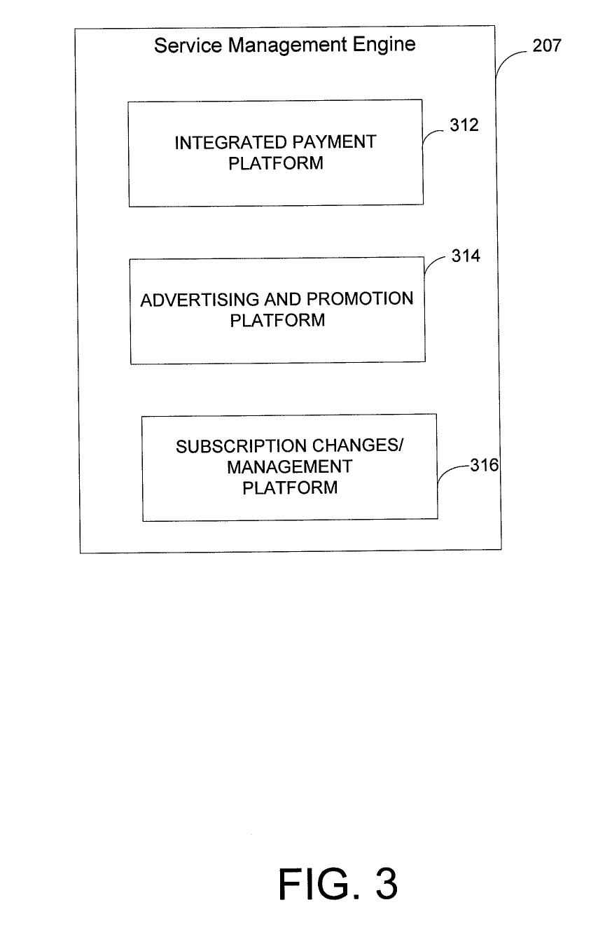

Turning to FIG. 3, additional details of service management engine 207 are illustrated. In the example embodiment of FIG. 3, service management engine 207 includes multiple components of which an integrated payment platform 312, an advertising and promotion platform 314 and a subscription changes/management platform 316 are illustrated. Collectively, the components of service management engine 207 receive information from multiple service providers related to subscriptions and charges associated with use of services in accordance with the subscriptions. The components of service management engine 207 may also receive from service providers advertising information. Though, other types of information may alternatively or additionally be received from service providers.

The components of service management engine 207 are adapted to provide a platform that service providers may access. The platform provides defined interface that are sufficiently generic to receive information from multiple service providers and relating to different types of services in accordance with subscriptions that have multiple and possibly different parameters. In reverse, the platform components of service management engine 207 may send information through those interfaces in a defined format such that any of the service providers, offering different types of services, with subscription agreements having different parameters, may receive and process the information.

In the embodiment illustrated in FIG. 1, the interfaces are physically implemented by communications sent over network 130. Accordingly, service management engine 207 may receive communications from multiple service provides through network interface 204. Communications over network interface 204 may be formatted in accordance with an interface standard defined by the platform components of service management engine 207. In this way, service management engine 207 may process communications from multiple service providers. In a similar way, service management engine 207 may send communications to one or more service provides through the interfaces defined by the platform components using the physical connection established by network interface 204 and network 130. These communications may be formatted in accordance with an interface standard defined by the platform such that service management engine 207 need not be customized to interface with different or additional service providers. Likewise, if communications are exchanged with intermediaries, they may be similarly formatted.

The communications to or from service providers handled by service management engine 207 may be triggered in any one of multiple ways. In some scenarios, service provides may initiate a communication that is processed by service management engine 207. A service provider, for example, may initiate a communication when a payment is due from a user, when a usage threshold is exceeding, when a subscription management function is due, such as a subscription renewal, or when the service provider has identified an additional service or feature of an existing service that may be of interest to the user.

Alternatively or additionally, such communications may be initiated by service management engine 207 polling service providers. The service providers polled may be identified in any suitable way. In some embodiments, local data base 210 may contain information from which service providers of interest to a user may be identified. As one simple example, local database 210 may contain a list of service providers with which a user has active subscription agreements. This list may be entered by a user or may be built automatically by the service management user 250 by adding service providers to the list as a user enters into new subscription agreements or removed when subscription agreements expire. In that scenario, service management engine 207 may periodically poll the service providers having active subscription agreements.

Additionally, service management engine 207 may handle communications triggered by user action. Service management engine 207 may initiate communications sent to one or more service providers based on user input obtained through a user interface defined by service stage 208. Such input may indicate that a function related to management of a subscription should be performed, such as that service management engine 207 should send a communication to cause a payment to a service provider. Other user input, for example, may trigger service management engine 207 to generate a communication to a service provide accepting an offer for a new service or an additional feature of an existing service. Likewise, service management engine 207 may receive user input indicating that a user wants to change a parameter of a subscription for an existing service.

Regardless of the specific action indicated by user input, in response to such user input, service management engine 207 may generate one or more communications effecting the explicit or implicit commands conveyed by the user input. In some embodiments, such communications may be directed to the service providers. Though, in some scenarios, the communications may be directed to one or more intermediary parties. For example, payment instructions may be directed to a financial institution, such as a bank or payment aggregator, and may indicate that a payment is to be made to a designated service provider.

To support such functions, service management engine 207 may contain multiple platform components, of which integrated payment platform 312, advertising and promotion platform 314 and subscription changes/management platform 316 are illustrated. Integrated payment platform 312 may receive information relating to charges or payment from one or more service providers or intermediaries. Integrated payment platform 312 may format or route the received information for processing elsewhere within user device 200. Such processing may include storing the information in local database 210 associated with the relevant service providers. Likewise, integrated payment platform 312 may receive user input, which in the embodiment of FIG. 2 may be received through service stage 208, and generate communications relating to payment functions and then direct these communications to one or more service providers and/or intermediaries.

Advertising and promotion platform 314 may similarly receive communications from one or more service providers and/or intermediaries and forward the information in those communications for further processing within subscription management utility 250. Such further processing may include storing the information in local database 210 and/or providing it to service stage 208 for presentation to a user. Advertising and promotion platform 314 may also generate communications to one or more service providers and/or intermediaries relating to user input accepting promotions or offers of services.

Subscription changes/management platform 316 may process communications from one or more service providers and/or intermediaries relating to parameters of a subscription, including communications relating to changes in those parameters. The received communications may identify current values of parameters associated with a subscription. As an example, subscription changes/management platform 316 may process communications identifying limitations on usage in accordance with a subscription. The messages processed within subscription changes/management platform 316 may alternatively or additionally identify other options for the values of parameters of the subscription agreement. Such communications, for example, may identify other values of parameters defining limits on use that a user may select. As with the other types of communications processed within service management engine 207, subscription changes/management platform 316 may extract information from communications received from service providers or intermediaries and store the information within local data base 210 or provided to other components within subscription management utility 250 for display to a user or other processing in connection with managing a subscription.

Subscription changes/management platform 316 may also receive user input, which may come through service stage 208 and may identify desired changes in subscriptions. In response to such user input, subscription changes/management platform 316 may generate communications to one or more service providers and/or intermediaries effecting such changes.

Service management engine 207 may interact with service stage 208 to provide information received from multiple service providers to service stage 208. Additionally, service management engine 207 may receive information from service stage 208 and provide that information to one or more service providers and/or intermediaries. Service stage 208 may present information obtained through service management engine 207 in a consistent manner regardless of the service or service provider with which it relates. To provide a consistent user experience, service stage 208 may be programmed with one or more generic engine components. Each of the engine components may be adapted to process information related to a subscription. The processing steps may be defined in a generic way. Though, the end result of the processing may be conditioned on parameters associated with a specific subscription.

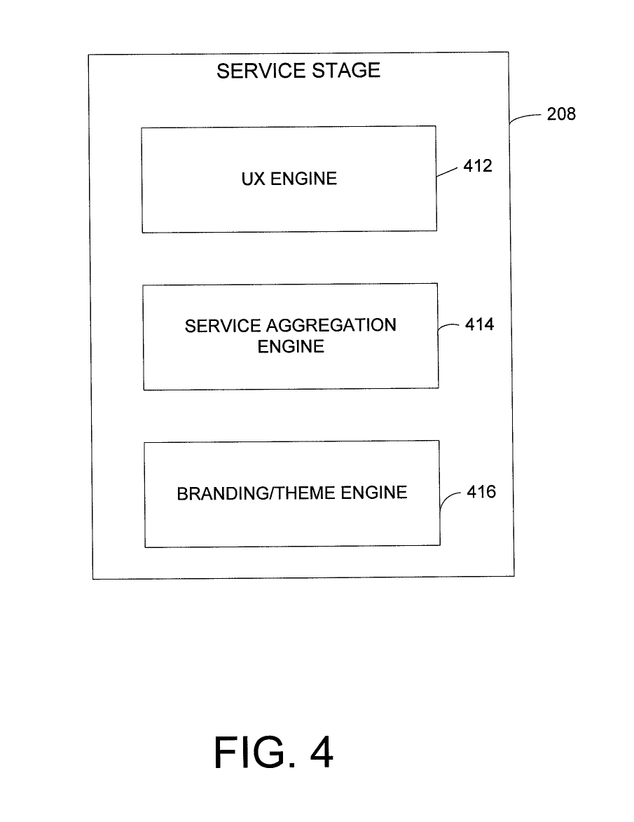

In the embodiment illustrated in FIG. 4, service stage 208 contains a user interface engine 412, a service aggregation engine 414 and a branding/theme engine 416. Each of these engines may be implemented as collections of computer executable instructions. Each collection of instructions may implement a function associated with management of a subscription. The result of executing any collection of instructions may, in some instances depend on the value of one or more parameters associated with a specific subscription associated with the collection of instructions at the time of execution. In this way, though service stage 208 may be programmed to be generic for multiple types of services, it may provide an appropriate user experience for each specific type of service to which a user has subscribed.

In the embodiment illustrated in FIG. 4, service stage 208 contains a user experience engine 412, service aggregation engine 414 and branding/theme engine 416. User experience engine 412 may contain collections of computer executable instructions that perform functions associated with displaying or receiving information, including commands, from a user. Such collections of instructions are sometimes referred to as “wizards.”

Each wizard may be a series of computer executable instructions that prompts a user to provide appropriate inputs in an appropriate order. The wizard may be programmed such that the specific inputs requested and the order in which the request are made is contingent upon values entered by the user, operating state of user device 200, information within local database 210 or other factors on which execution may be conditioned. Though service management engine 207 may be extensible to accept wizards uniquely associated with a specific service or service provider, the platform components of user experience engine 412 may contain generic wizards adapted for use with multiple services providers of different type. The generic wizards may be customized for actions associated with a specific service provider because a specific service provider for which a subscription management function is to be performed may be part of the state information that influences operation of the wizard.

As one example, user experience engine 412 may contain a wizard adapted to obtain user input concerning an increase in a usage limit. Such a wizard may, for example, operate by accessing information about any one of the services stored in local data base 210. That information may include a current limit and other possible limits that may be selected and associated costs for each of the additional selections. A generic wizard may generate information for display on a user interface that represents in a graphical fashion a current limit for a subscription parameter and the alternatives that may be selected by the user. Such interface may incorporate payment information associated with the various options. Additionally, such an interface may present to a user an option to request details of any one of the options.

The wizard may be programmed such that, in response to user input requesting details of an option, the wizard may interact with subscription management/changes platform 316, to cause the platform to generate a communication to a service provider requesting plan details associated with the service option. The wizard may then, based on information subscription management/changes platform 316 receives from the service provider, generate a further user interface.

The wizard may also be adapted to receive user input indicating a selection of one of the options. In response to such user input, the wizard may again interact with subscription changes/management platform 316 to generate a communication to the service provider indicating a change of a value of a parameter of the subscription agreement to reflect that user selection. In response, the wizard may receive through subscription management/changes platform 316 a confirmation of the change, which may be presented to the user.

It should be recognized that the processing associated with receiving user input relating to changing a subscription may be performed, as described above, by interaction of multiple components with subscription management utility. The partitioning of functions between these components is not critical to the invention. For example, the wizard may automatically store a confirmation of a change by updating information about the subscription in local database 210. As a specific example, the wizard may update a value indicating the selected usage level in accordance with the subscription agreement. Though, updating of the database could also be done by subscription management/changes platform 316.

The foregoing provides an example of a wizard that may be incorporated in subscription management utility 250. Such a wizard may provide a consistent user interface for making subscription changes relating to usage limits, regardless of the type of service. Accordingly, the same wizard may be employed with each of multiple service providers, even though the type of service provided by each service provider may be different. In this way, subscription management utility 250 may provide a consistent user experience in connection with changing a service limit, regardless of the type of service. Subscription management utility 250 may contain other types of wizards associated with other actions to be performed in managing subscriptions. In this way, a consistent user experience across all subscription management functions may be provided.

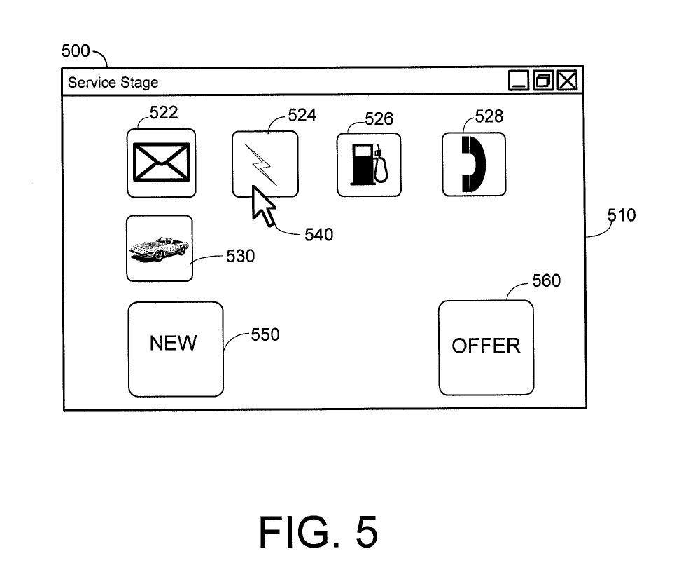

Service aggregation engine 414 may contain collections of instruction that present to a user information about multiple types of services concurrently. An example of such aggregation is provided in conjunction with FIG. 5 below.

Branding/theme engine 416 may contain collections of instructions that perform functions relating to displaying information about specific services in a way that allows a user to associate displayed information with specific services. Though, as described above, service stage 208 provides a consistent user experience regardless of the nature of a service or service provider from which that service is obtained, branding/theme engine 416 may customize the user interface such that a user may readily recognize either the nature of the service about which information is provided or a service provider through which that service is obtained. An example of the functioning of branding/them engine 416 is also provided in FIG. 5.

FIG. 5 illustrates a user interface 500 that may be generated on a display of user device 200. FIG. 5 is implemented as a graphical user interface and may be rendered using programming techniques as are known in the art. User interface 500 is an example of presenting a consistent user experience for multiple services of different types. Yet, branding and them information associated with each of the services is also included. Accordingly, FIG. 5 is an example of a user interface generated by interaction of the engine components within service stage 208.

FIG. 5 illustrates a scenario in which subscription management utility 250 had obtained information associated with five services of interest to user 112. User interface 500 may represent a starting using interface that is presented to a user when the user enters input into user device 200 initiating access to subscription management utility 250. In the embodiment illustrated in FIG. 5, user interface 500 includes a common display area 510 in which available services to manage are depicted in a common format. Yet, each representation has been customized by branding/theme engine 416 to allow a user to readily identify services or service provides associated with each representation.

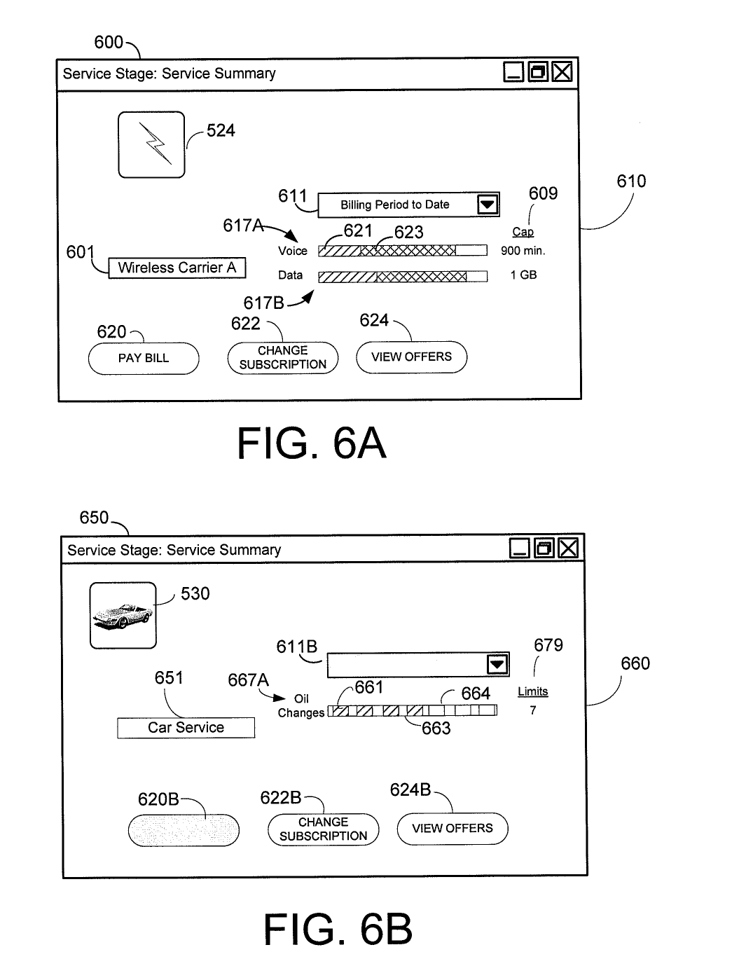

In the embodiment of FIG. 5, a wizard within user experience engine 412 has generated a display such that display area 510 contains icons representing each of five services for which subscription management 250 has found data stored in local database 210. The services are represented by icons 522, 524, 526, 528 and 530, respectively. As can be seen, each of the icons has a consistent shape and purpose. Namely, when a user selects an icon associated with a service, further information about that service may be presented. For example, a user may position a cursor 540 on an icon, such as icon 524, and select that icon. In response, the subscription management utility 250 may present a further user interface, such as that shown in FIG. 6A, providing information about the service associated with icon 524. Selecting an icon alternatively or additionally may trigger subscription management utility 250 to present a further user interface (also as illustrated in FIG. 6A) through which a user may input commands to manage the subscription.

Nonetheless, each of the icons, though performing a similar function, is visually distinctive as a result of the operation of branding/theme engine 416. As can be seen from the example in FIG. 5, icon 522 is associated with the subscription to an email service. Icon 524 is associated with a subscription to a wireless communication service. Icon 526 is associated with a subscription to a service that provides pre-paid gasoline. Icon 528 is associated with a telephone service and icon 530 is associated with an automotive service.

The specific appearance of each of the icons is not critical to the invention and the appearance of each icon may be generated in any suitable way. For example, one type of communication sent from a service provider may include an identification of a corporate logo or other graphic element acting as a preferred icon for that service provider. Service management engine 207 may treat such information identifying an icon or theme for a specific service provider as any other information associated with a specific service. Accordingly, service management engine 207 may store such branding or theme information on local database 210 in conjunction with a service. When service stage 208 generates a user interface, branding/theme engine 416 may obtain this information and render an icon associated with the theme with the specified visual appearance.

FIG. 5 also illustrates other functions that may be performed through a user interface rendered by subscription management utility 250. In this case, controls 550 and 560 are illustrated. In this example, control 550 initiates an action by which a user may input information indicating that subscription management utility 250 should obtain information concerning a new service provider. Activating control 550 may trigger a wizard within user experience engine 412 to guide a user through a process of providing or obtaining information about the subscription. As a specific example, the steps of the process may involve prompting a using to identify the type of service and the service provider. The steps of such a process may relate to obtaining information about a service to which the user has already subscribed. Alternatively, the steps of the process may involve entering into a new subscription agreement with a service provider.

Control 560, if activated by a user, may trigger subscription management utility 250 to perform functions associated with accepting an offer for services. The services offered may be new services or may be additional features associated with an existing service. In scenarios in which the services offered are new services, user input activating control 560 may launch a wizard that is the same as the wizard launched in response to a user activating control 550. However, when the wizard is launched in response to an offer, certain information, such as information concerning the service or service provider, may be part of the state information accessed by the wizard. As a result, some of the steps that would be performed by the wizard when invoked in response to user activation of control 550 may be omitted. Nonetheless, the user experience may be consistent for the function of establishing a new subscription.

FIG. 5 illustrates that control 560 has a generic shape. Though, in some embodiments, branding or theme information may be associated with control 560 based on the service provider that has made the offer such that visual differences are apparent to the user, which may aid the user in identifying a service provider associated with an offer. As one example of how this result may be achieved, advertising and promotion platform 314 (FIG. 3) may receive information from a service provider that triggers service stage 208 to render a user interface including control 560. In conjunction with the information obtained by advertising and promotion platform 314, branding or theme information may be obtained. Accordingly, though FIG. 5 shows a generic control 560, as actually rendered by service stage 208, control 560 may be surrounded by branding or theme information that alerts the user to the nature of the offer that is being presented and/or a service provider making the offer.

FIG. 5 provides just one example of the format of a user interface that may be rendered by the combined action of the engines within service stage 208. Variations are possible. For example, alternative representations of available services may be used. As a specific example, rather than displaying each service as a separate icon, available services may be listed. Though, even if available services are identified in another way, user interface 500 may nonetheless present information relating to multiple services in a common display area. As an example of another variation, multiple controls, such as control 560, relating to available offers may be displayed. Though, in other embodiments, offers related to existing services may be displayed only in conjunction with information on those services.

Regardless of the format in which information about services available for management are displayed, subscription management utility 250 may present other user interfaces relating to functions that may be performed when a user selects a service to manage. FIG. 6A illustrates one such alternative user interface. Graphical user interface 600 may be rendered by service stage 208 in response to user input indicating that the subscription associated with the service provider represented by icon 524 is to be managed. As can be seen, user interface 600 includes a display area 610 in which information relating to the subscription is displayed. In addition, user interface 600 contains controls that a user may access to both change the nature of information displayed and to provide user input commanding operations relating to subscription management.

In the embodiment illustrated, display item 601 identifies a service provider by name. In some embodiments, display item 601 may be a control that, if selected by a user, invokes a component within user experience engine 412 (FIG. 4) that obtains information about the service provider and presents it in another display area. In this example, the service provider is identified as “Wireless Carrier A,” and the information in display area 610 relates to a service provided by Wireless Carrier A.

In FIG. 6A, display area 610 has been branded to allow a user to associate the information with Wireless Carrier A. For example, icon 524, associated with that service provider is illustrated. This branding may be presented by branding/theme engine 416. Also, though not illustrated, branding/theme engine 416 could control the theme in display area 610 to provide indications to a user that the information in display area 610 is associated with Wireless Carrier A. That theme information, for example, could include a background including colors or image associated with Wireless Carrier A. The theme could alternatively or additionally include other display elements, such as images or display items that are displayed.

Other display items may be generated by a generic wizard. For example, display item 611 is a control that allows a user to specify a time frame for which subscription data is provided. In the embodiment illustrated in FIG. 6A, a user has selected to display information related to a billing period to date. The components within user experience engine 412 may support any number or format of time periods or other mechanisms by which a user may specify information to be displayed.

In the example illustrated, the user's subscription to the service provided by Wireless Carrier A contains multiple usage parameters, which are reflected in the user interface 600. In this example, those usage parameters relate to an amount of voice service and an amount of data service used by the subscriber. Additionally, the parameters for the subscription include allowances for usage of voice service and data service.

In the specific example illustrated in FIG. 6A, voice data usage is presented to the user through graphical indicator 617A. Data usage is presented to the user through graphical indicator 617B. In this example, graphical indicators 617A and 617B are formatted as progress bars, showing progress towards use of the allocation for each parameter of the subscription. Accordingly, graphical indicator 617 includes two visually distinct regions 621 and 623. In this example, region 621 indicates a portion of the plan allowance used in the current billing period. Region 623 is a graphical indication of the amount of voice data usage that remains in the subscription allowance for the billing period to date. Similar visually distinct regions appear in graphical indicator 617B, indicating usage towards an allowance of data services.

Alternatively, or additionally information may be displayed in fashions other than through the use of progress bars. As an example, subscription information may be displayed as text information. Accordingly, FIG. 6A illustrates a text region 609. Text region 609 contains, in textual format, an indication of the value of subscription allowances. In this example, each of the usage parameters has an associated allowance. For example, the plan allowance for voice usage is shown to be 900 minutes. The subscription allowance for data usage is shown to be 1 GB.

FIG. 6A illustrates that, upon selecting a service provider, information associated with a subscription to a service provided by that service provider may be presented through a graphical user interface. Additionally, graphical user interface 600 may include commands through which a user may initiate actions related to management of the subscription. In the example of FIG. 6A, user interface 600 is shown to include controls that may be selected by a user to initiate subscription management functions.

Any suitable mechanism may be employed to implement those subscription management functions in response to user selection of a control. However, in some embodiments, each of the controls may be linked to a component within user experience engine 412 such that the component is executed upon user selection of the linked control. As described above, user interface engine 412 may include generic wizards that guide a user through performing subscription management functions. In the specific example of FIG. 6A, control 620 may be linked to a wizard that guides a user through a process of paying a bill.

When control 620 is selected in conjunction with user interface 600 operation of a wizard is related to a specific service provider, in this case Wireless Carrier A, that has already selected by a user. Accordingly, though the wizard linked to control 620 may be a generic wizard, the previous selection of Wireless Carrier A may act as state information used by the generic wizard such that, upon execution, the wizard guides a user through a process of paying a bill due to Wireless Carrier A. In some embodiments, the wizard may prompt a user for input during the process of paying a bill. Though, in other embodiments, a wizard within user experience engine 412 may, based on a previous designation of a service provider and information stored within local database 210, complete the process of paying a bill without further user input.

Accordingly, some or all of the controls included within user interface 600 may involve user interactions while others do not. For example, control 622, if selected by a user, may invoke a wizard through user experience engine 412 (FIG. 4) that receives user input identifying subscription changes. A wizard executing in response to selection of control 622 may obtain information about the current subscription in any suitable way. Such a wizard, for example, may access information stored in local database 210 (FIG. 2A) or may interact with subscription changes/management platform 316 (FIG. 3) to initiate requests for information from the service provider and obtain responses from the service provider. The wizard within user experience engine 412 may use the responses to generate a user interface providing the user with information about current subscription options. Through such a user interface, the wizard may obtain user input designating a selection of new subscription options, which may be communicated to a service provider through interaction with subscription changes/management platform 316.

FIG. 6A shows a further control 624 that, when selected by a user, may result in a display of offers, such as in the form of advertisements or special promotions, from the service provider for which information is provided through user interface 600. The format in which information on offers is presented is not critical to the invention and any suitable format may be used. Also the mechanism that renders a display is not critical to the invention. However, as with other controls displayed in graphical user interface 600, selecting control 624 may invoke a wizard within user experience engine 412 that interacts with information stored in local database 210 or interacts with components within service management engine 207 to exchange information with the service provider. In the scenario in which information is exchanged with the service provider, the component of user experience engine 412 invoked in response to a user selecting control 624 may interact with the service provider through advertising and promotion platform 314.

As described above, the elements of graphical user interface 600 may be generated based on generic wizards or other components that can function regardless of a service provider for which information is to be displayed or subscription management operations are to be performed. As a result, similar operations performed for any service provider may have a consistent look from the perspective of a user. FIG. 6B, for example, illustrates a graphical user interface 650 that may be displayed in response to a user selection of a service provider associated with icon 530 in graphical user interface 500 (FIG. 5). In this example, commonality of display elements may be seen, despite the fact that the information in graphical user interface 650 relates to a different service and different service provider than associated with graphical user interface 600.

In this specific example, graphical user interface 650 relates to a service provider identified as car service. Nonetheless, graphical user interface 650 includes a display item 651 that corresponds to display item 601. In this example, user selection of display item 651 obtains additional information about a service provider, though the specific service provider for which information is displayed is different if display item 651 is selected than if display item 601 is selected.

Other elements of commonality may be seen. For example, branding/theme engine 416 may render in each case an icon representing this service provider. Though, as can be seen by a comparison of FIGS. 6A and 6B, graphical user interface 600 displays icon 524 while graphical user interface 650 displays icon 530.

Correspondence between other display elements may be seen. For example, display item 611B may correspond to display item 611, both of which allow a user to select a timeframe for which subscription information is displayed. However, in the example of FIG. 6B, the service relates to a car service and involves prepayment for a limited number of oil changes. Accordingly, the subscription agreement associated with the service depicted in graphical user interface 650 has no time parameter associated with it. Accordingly, display item 611 is shown grayed out, indicating that no time information is associated with the subscription. Though, it should be appreciated that display item 611B is shown grayed out as an example of a display technique that may be used to indicate when no data is associated with a subscription parameter. However, alternative display techniques may be used, including omitting from the display associated with a service display items associated with parameters for which there is no data relevant to that service.

FIG. 6B illustrates other display items that correlate with those in user interface 600. For example, a graphical indicator 667A is shown. Graphical indicator 667A may be regarded as displaying a form of usage information related to the subscription represented in FIG. 6B. In this example, graphical indicator 667A indicates a number of oil changes that have been used towards a subscription allowance. Accordingly, progress bar 663 in this example includes a number of discrete regions which may be displayed in a visually distinctive way to designate oil changes that have been used and those that remain towards the subscription allowance. For example, region 661 appears differently than region 664. In this example, region 661 indicates an oil change used while region 664 indicates an oil change remaining under the subscription allowance.

Graphical user interface 650 also may include a text region 679. In text region 679, a plan allowance associated with a number of oil changes is presented in text form.

User interface 650 may also include controls that a user may select to perform subscription management functions. In this example, controls 622B and 624B are shown. These controls correspond to controls 622 and 624 in FIG. 6A. Selecting controls 622B and 624B may result in operations being performed that correspond with those performed upon selection of controls 622 and 624, respectively. However, upon selection of controls 622B and 624B associated with graphical user interface 650, the functions may relate to services provided by the service provider Car Service. For example, selecting control 622B may allow a user to modify the number of oil changes covered by the subscription.

In this example, the services provided are pre-paid services. Consequently, a bill payment function is not applicable to the service depicted through graphical user interface 650. Accordingly, control 620B, which corresponds to control 620, is shown grayed out in FIG. 6B. However, as noted above, any suitable display technique may be used to represent that various functions are not applicable to a particular service.

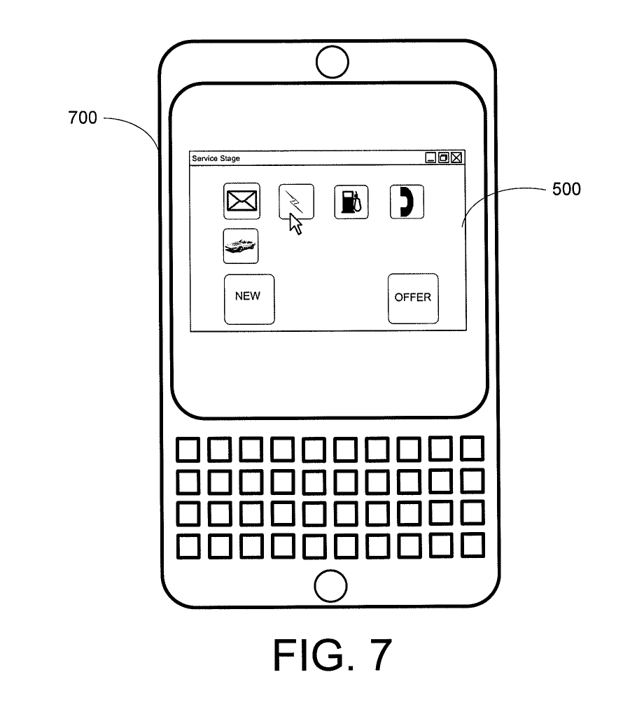

Comparison of FIG. 6A and 6B reveals that subscription management utility 250 may present a consistent user experience associated with management functions for any of multiple services provided by any number of service providers. FIG. 7 illustrates that a consistent experience may be provided by accessing a subscription management utility on different user devices. FIG. 7 illustrates a portable electronic device, such as smart phone 700. As known in the art, a smart phone may be regarded as a computing device containing a processor that may execute the computer executable instructions comprising subscription management utility 250. Accordingly, smart phone 700 may display graphical user interface 500 as described above or any other display that may be generated by subscription management utility 250.

In some embodiments, subscription management utility 250 may run on a user's smart phone 700 instead of executing within user device 200 (FIG. 2A). However, in other embodiments, a user may desire to manage subscriptions both through a computing device 200 and a smart phone 700. In such embodiments, a local database associated with an instance of subscription management utility executing on user device 200 and a local database associated with an instance of subscription management utility 250 executing on smart phone 700 may be synchronized using synchronization methods as were known in the art.

Though, in other embodiments, a user may access subscription management functions from multiple devices, even without synchronizing those devices, if information used by both instances is obtained from the same location. As one example, subscription management utility 250 may be adapted such that no information is stored in a local database. Rather, information could be obtained from service providers as used. As another alternative, each instance of the subscription management utility may access data from a common networked location. As one example, an intermediary may store such data. In the example of FIG. 1, the data may be stored in a database 152 accessible to the devices that will execute an instance of subscription management utility 250.

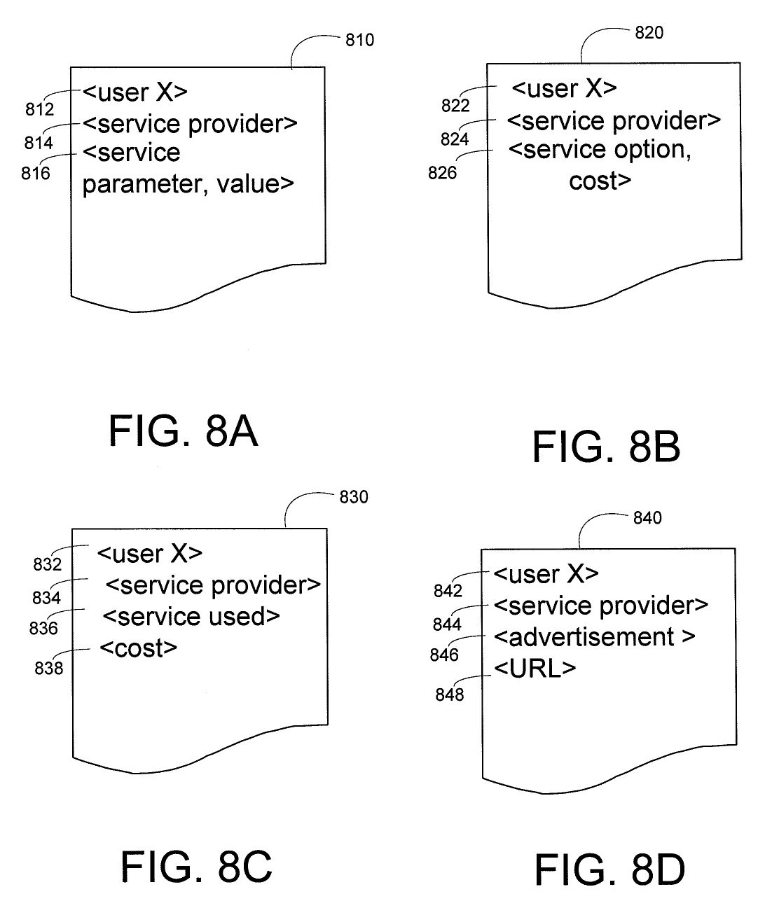

As described above, service management engine 207 provides platforms through which service providers may provide information. The platforms may employ interfaces through which messages of defined formats may be exchanged. FIGS. 8A, 8B, 8C and 8D provide examples of messages that may be sent from a service provider to subscription management utility 250 through the platform provided by service management engine 207.

FIG. 8A illustrates schematically a message 810 that may be sent from a service provider. Message 810 includes multiple fields. A first field, field 812, for example, may identify a subscriber about which information is provided in message 810. Field 814 may identify the service provider that generated the information in message 810. Field 816 may identify a value for an identified service parameter. As will be appreciated, components within subscription management utility 250 may use the content of message 810 to provide information to a user. Though, it should be recognized that message 810 is a conceptual illustration of a message and that an actual message may contain multiple additional or different fields. For example, field 816 identifying a service parameter and a corresponding value of that service parameter may be duplicated multiple times for a service characterized by multiple service parameters.

FIG. 8B provides another example of a message that may be sent from a service provider to subscription management utility 250. In this case, message 820 includes a field 822 identifying a subscriber to which the message relates. Field 824 identifies a service provider. Field 826 identifies an optional service feature and an associated cost. As with message 810, message 820 may include additional or different fields, including multiple instances of field 826 when a subscription has multiple options.

FIG. 8C illustrates an example of another message that may be sent from a service provider. In this example, message 830 includes fields 832, 834, 836 and 838. Field 832 identifies a subscriber. Field 834 identifies a service provider. Field 836 identifies an amount of service used. Field 838 identifies a cost associated with the service used.

FIG. 8D illustrates yet another example of a message that may be sent from a service provider. In this example, message 840 includes fields 842, 844, 846 and 848. Field 842 identifies a subscriber. Field 844 identifies a service provider. Field 846 identifies that message 840 is being sent to notify subscription management utility 250 of an advertisement applicable to the subscriber identified in field 842. In this example, information about the advertisement is conveyed as a network address at which content identifying the offer may be obtained. That network location is identified by the URL within field 848.

FIGS. 8A . . . 8D conceptually illustrate messages that may be sent from service providers to subscription management utility 250 to provide information about subscriptions. One of skill in the art will appreciate that alternative or additional messages may be sent.

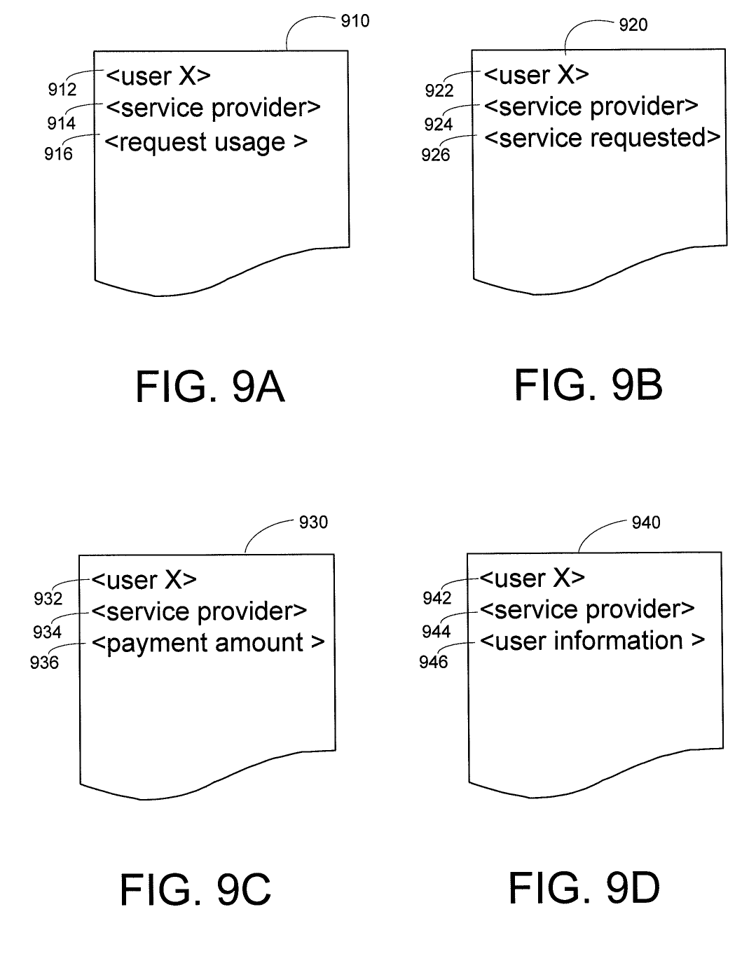

In the examples of FIGS. 8A . . . 8D, the messages are in a format that may be applicable to any one of numerous service providers providing different types of services. Messages with a common format may similarly be sent from subscription management utility 250 to service providers. As described above, such messages may be generated based on execution of components within service stage 208, which may occur either automatically or in response to user inputs. FIGS. 9A, 9B, 9C and 9D provide examples of messages that may be sent from subscription management utility 250.

FIG. 9A illustrates a message 910. Message 910 includes fields 912 and 914 that identify a subscriber and a service provider to which message 910 is directed, respectively. Message 910 also includes field 916 which, in this example, identifies message 910 as a request for usage data.

FIG. 9B illustrates an example of another message that may be sent from subscription management utility 250. In this example, message 920 includes fields 922 and 924 identifying a subscriber and service provider to which message 920 is directed, respectively. Message 920 also includes field 924 identifying a service requested by the subscriber. Such a message, for example, may be sent in response to a user initiating a wizard to change a subscription to include additional service features.

FIG. 9C illustrates a further message that may be sent to a service provider. In this example, message 930 includes a field 932 identifying a subscriber and a field 934 identifying a service provider. Message 930 additionally includes field 936 identifying a payment amount. In this example, message 930 may be an instruction to initiate a payment. In examples in which payments are processed by a third party financial institution, though message 930 may be generated by subscription management utility 250, it may be directed to the third party financial institution rather than the service provider directly.

As yet a further example, FIG. 9D shows a message 940. Message 940 includes fields 942 and 944 that identify a subscriber and a service provider, respectively. Message 940 also includes field 946 conveying user information. As described above, subscription management utility may include a feedback engine 209 that collects information concerning a user and provides it to service providers. Service providers may use such information to identify services that may be of interest to the user and generate advertisements or other offers for those services directed to the user. Message 940 represents a mechanism by which such information may be conveyed. Though, in the embodiments described above, message 940 may be sent only upon receiving user authorization to disclose user information to service providers.

It should be recognized that the messages illustrated in FIGS. 9A, 9B, 9C and 9D are illustrated of the types of messages that may be sent by subscription management utility 250. The number and types of messages may vary in embodiments based on the functions supported by subscription management utility. Accordingly, messages 910, 920, 930 and 940 should be regarded as illustrative and not limiting.

Having thus described several aspects of at least one embodiment of the invention, it is to be appreciated that various alterations, modifications, and improvements will readily occur to those skilled in the art.

As one example, components of the platform may be implemented by an intermediary rather than being relevant on the computing device of the user. In some embodiments, for example, the service management engine may be operated by the intermediary. Though, in some embodiments, some or all of the components of the service management engine resides on a user computer. For example, in some embodiments, computer-executable instructions that, when executed, implement the service management engine may be resident on a user computer. However, data collected by the service management engine may be hosted by the intermediary or on a networked computer that is accessible from any one of multiple computing devices through which a user may perform service management functions.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computing device comprising at least one processor and a display, the method comprising:
presenting on the display a common interface area;
presenting within the common interface area a plurality of icons, each icon representative of a service of a plurality of services, the plurality of services comprising services of a plurality of different types;
receiving user input identifying an identified service of the plurality of services;
in response to the user input, displaying information relating to a subscription to the identified service; and
receiving user input relating to managing a subscription to the identified service.

2. The method of claim 1, wherein the plurality of services comprise a wireless communication service.

3. The method of claim 2, wherein the plurality of services further comprises a service related to an automobile.

4. The method of claim 1, further comprising:
providing information relating to usage of a service of the plurality of services to a provider of the service.

5. The method of claim 4, further comprising receiving from the provider of the service an advertisement for an additional feature associated with the service.

6. The method of claim 5, wherein the additional feature relates to the provided information.

7. The method of claim 1, wherein:
receiving user input relating to managing a subscription comprises receiving user input instructing that a payment be made to a provider of the identified service; and
the method further comprises transmitting a message instructing a payment be made to the provider of the identified service.

8. The method of claim 7, wherein displaying information relating to the subscription to the identified service comprises a current amount owed by a user of the computing device to the provider of the identified service.

9. The method of claim 1, wherein
receiving user input relating to managing a subscription comprises receiving user input instructing that a change be made to usage allowance for the identified service; and
the method further comprises transmitting a message to the provider of the identified service indicating a change be made to the usage allowance.

10. At least one non-transitory computer storage medium encoded with computer-executable instructions that, when executed by a processor implement a plurality of components for implementing a subscription management utility on a computing device, the plurality of components comprising:
a service management engine adapted to receive communications from each of a plurality of service providers, each service provider providing a service of a plurality of services, the plurality of services comprising a plurality of different type services;
a service stage adapted to display, in a consistent format, information related to the plurality of services;
a feedback engine adapted to collect user information relating to activities of a user associated with usage of services of the plurality of services or usage of the computing device and provide the user information to one or more of the plurality of service providers.

11. The at least one non-transitory computer storage medium of claim 10, wherein the service stage comprises a wizard adapted to present a user interface relating to changing a service, the wizard presenting information relating to changing each of the plurality of services in the consistent format.

12. The at least one non-transitory computer storage medium of claim 10, wherein the service management engine comprises an integrated payment platform adapted for conveying payment instructions for payment to each of the plurality of service providers.

13. The at least one non-transitory computer storage medium of claim 10, wherein the service management engine further comprises and advertising platform adapted to receive an advertisement from a service provider of the plurality of service providers and present the advertisement to the service stage for display to a user at a time correlated with display of information related to an existing service of the plurality of services.

14. The at least one non-transitory computer storage medium of claim 13, wherein:
the advertisement relates to an additional feature associated with the existing service;
the service stage is adapted to display the advertisement to the user at a time correlated with display of information related to the existing service by displaying in a user interface presenting in a common interface area data associated with the existing service and an indication that the additional feature is available.

15. The at least one non-transitory computer storage medium of claim 10, wherein:
the at least one non-transitory computer storage medium further comprises computer-executable instructions comprising an operating system for the computing device; and
the plurality of components comprise a portion of the operating system.

16. A method of operating a computing device coupled to a network and comprising at least one processor, the method comprising:
with the at least one processor, implementing a service management engine that operates in accordance with a method comprising:
sending first communications in response to receiving input from a user, the first communications relating to instructions associated with management of subscriptions to each of a plurality of services;
receiving second communications over the network from a plurality of service providers providing the plurality of services, each second communication providing information about a service subscription associated with the user; and
receiving third communications from the plurality of service providers, the third communications comprise offers for the user to procure services or service features;
wherein, the plurality of services comprise services of a plurality of types.

17. The method of claim 16, wherein the first type communications further comprise instructions to effect payment for services of the plurality of services.

18. The method of claim 16, wherein each of the second communications comprises a communication in a defined format comprising a plurality of fields, a first field of the plurality of fields comprising an identifier of a service provider.

19. The method of claim 18, wherein each of the second communications comprises a communication in a defined format comprising a plurality of fields, a second field of the plurality of fields comprising an identifier of the user.

20. The method of claim 16, wherein:
receiving the first communications comprises receiving user input through a wizard adapted to guide a user through a process of managing an operation associated with a service subscription.
